(19) United States
(12) Patent Application Publication
(10) Pub. No.: US 2015/0125337 A1
(43) Pub. Date: May 7, 2015

(54) METHOD FOR PRODUCING RARE EARTH SINTERED MAGNET, AND MOLD

(71) Applicant: HITACHI METALS, LTD, Tokyo (JP)

(72) Inventors: Takashi Tsukada, Kishima-gun (JP); Takuya Nansaka, Kishima-gun (JP); Satoru Kikuchi, Kumagaya-shi (JP)

(73) Assignee: HITACHI METALS, LTD., Tokyo (JP)

(21) Appl. No.: 14/411,180

(22) PCT Filed: Jun. 25, 2013
(86) PCT No.: PCT/JP2013/067338

§ 371 Date: Dec. 24, 2014

(30) Foreign Application Priority Data
Jun. 29, 2012 (JP) 2012-146708

(51) Int. Cl. H01F 41/02; B22F 3/22; B22F 3/00; H01F 1/08

(52) U.S. Cl. CPC H01F 41/0266; H01F 1/086; B22F 3/225; B22F 3/004; H01F 41/0273
USPC 419/40; 425/78

(57) ABSTRACT

The present invention provides a method for producing a rare earth sintered magnet, capable of reducing variation in magnetic characteristics of a rare earth sintered magnet and suppressing deformation of the rare earth sintered magnet. Disclosed is a method for producing a rare earth sintered magnet, including the steps of:
preparing a slurry including an alloy powder and a dispersion medium at a predetermined ratio, the alloy powder containing at least a rare earth element;
preparing a cavity enclosed with a mold, and an upper punch and a lower punch spaced from and opposed to each other, at least one of the upper punch and the lower punch being movable toward and away from the other one, at least one of the upper punch and the lower punch including an outlet for discharging the dispersion medium of the slurry and filtering the slurry, the mold having a cross sectional shape perpendicular to the sliding direction of the upper punch or the lower punch, the cross sectional shape being enclosed with an approximately arc-shaped outer circumference, an approximately arc-shaped inner circumference, and a pair of side circumferences connecting between the outer circumference and the inner circumference, a ratio of a distance between farthest ends of a pair of side circumferences to a distance between a top end of the outer circumference and a top end of the inner circumference being 1.5 or more, the upper punch or the lower punch being allowed to slide in a through-hole formed in the sliding direction along an outer peripheral surface including the outer circumference, an inner peripheral surface including the inner circumference, and the side circumference surfaces including the side circumferences;
injecting the slurry into the cavity in a state where the upper punch and the lower punch remain stationary to fill the cavity with the slurry, a magnetic field being applied to the cavity;
producing a molded body of the alloy powder by press molding in the magnetic field, the upper punch and the lower punch coming closer to each other while applying the magnetic field; and
sintering the molded body;
wherein the slurry is injected into the cavity so that the slurry travels from one place of the top end in the cross section perpendicular to the sliding direction of one of the outer peripheral surface and the inner peripheral surface, to one place of the top end in the cross section perpendicular to the sliding direction of the other one of the outer peripheral surface and the inner peripheral surface.

### TECHNICAL FIELD

The present invention relates to a method for producing a rare earth sintered magnet, particularly, a method for producing a rare earth sintered magnet using a wet molding method for molding a slurried magnetic powder in a magnetic field.

### BACKGROUND ART

Rare earth sintered magnets, such as R-T-B-based sintered magnets (R means at least one of rare earth elements (concept including yttrium (Y)), T means iron (Fe) or a combination of iron and cobalt (Co), and B means boron) and samarium-cobalt-based sintered magnets are widely used because of excellent magnetic characteristics such as a residual magnetic flux density Bᵣ (hereinafter simply referred to as “Bᵣ”) and a coercive force H_{cj} (hereinafter simply referred to as “H_{cj}”).

Particularly, R-T-B-based sintered magnets are used for various applications, including various motors such as voice coil motors (hereinafter sometimes referred to as “VCM”) of hard disk drives, motors for hybrid vehicles, motors for electric vehicles, and various motors for home electric appliances, or various sensors, because of the highest magnetic energy product among various conventionally known magnets and the affordable low price.

Parts including such various motors and sensors are demanded for more improvement in magnetic characteristics of rare earth sintered magnets such as R-T-B-based sintered magnets for the sake of size reduction and weight reduction or increase in efficiency for various usages.

A method for reducing oxygen content in the sintered magnet has been known as a method for improving magnetic characteristics of the R-T-B-based sintered magnet. An effective method for reducing the oxygen content in the sintered magnet is a wet molding method in which an alloy with the required composition is ground and the alloy powder thus obtained is dispersed in a dispersion medium such as oil to obtain a slurry, and then the obtained slurry is molded by injecting into a mold. Since employment of the wet molding method suppresses oxidation of the alloy powder using a dispersion medium such as oil, the oxygen content can be reduced, thus enabling an improvement in magnetic characteristics.

With the improvement of magnetic characteristics, there has recently been a need to reduce variation in magnetic characteristics in rare earth sintered single molded bodies such as an R-T-B-based sintered magnet. The variation in magnetic characteristics in the rare earth sintered single magnet bodies such as an R-T-B-based sintered magnet will disturb control of motors and sensors. Enhanced magnetic characteristics lead to an increase in influence of a magnetic force, thus requiring further reduction of variation in magnetic characteristics.

Particularly, rare earth sintered magnets such as an R-T-B-based sintered magnet for use in VCM has, as shown in FIG. 8, an approximately tile shape (“approximately tile shape” means a shape having a cross-sectional shape enclosed by an outer circumference and an inner circumference which are curved in the same direction and face to each other, and a pair of side circumferences connecting between both ends of the outer circumference and both ends of the inner circumference, and having a required length in a direction perpendicular to the cross section), and may have, as shown in FIG. 9, a complicated shape having a portion 45 which is called as a latch section. Therefore, it is difficult to uniformly inject the slurry into the mold, as compared with a block-shape, in the wet molding method, thus causing remarkable variation in magnetic characteristics.

Patent Document 1 discloses a method for uniformly injecting a slurry. In Patent Document 1, in a method for producing a rare earth permanent magnet, tip of a supply pipe for supplying the slurry is inserted into a cavity at the position in the vicinity of the bottom of the cavity and, and then the slurry is appropriately drawn to fill the cavity while discharging the slurry upwardly from the bottom of the cavity. Whereby, the cavity having a narrow opening and a large depth can be filled with the slurry into every corner.

However, the method disclosed in Patent Document 1 further needs facilities such as a supply head for supplying the slurry and a transfer means for transferring the slurry. In addition, since the supply pipe for supplying the slurry must be inserted into the cavity in the vicinity of the bottom of the cavity from an upper punch side, it takes a long time to move the supply head and the supply pipe to cause problem such as deterioration of production efficiency. In Patent Document 1, the slurry is injected while opening the cavity, thus failing to apply a pressure to the slurry, which leads to limitation on filling the slurry into every corner of the cavity.

Patent Documents 2 and 3 disclose a wet molding method for molding a ferrite magnet in which the slurry is injected from an approximately tile-shaped side surface (see, FIG. 3 of Patent Document 2 and FIG. 2 of Patent Document 3). However, in the above mentioned R-T-B-based sintered magnet, when the inventors performed wet molding by injecting the slurry from the approximately tile-shaped side surface in the same manner as in Patent Documents 2 and 3, the following problems occurred.

Specifically, the R-T-B-based sintered magnet obtained by sintering after the wet molding was divided into two pieces at the center of the approximately tile-shaped magnet in a manner as shown in FIG. 8 (an area far from the inlet for injecting a slurry is referred to as an area A, and an area close to the inlet is referred to as an area B). Then, magnetic characteristics were measured for each of the areas A and B. As a result, there was such a problem that a large difference in magnetic characteristics between the areas A and B occurs to generate variation in magnetic characteristics. There was also a problem that the R-T-B-based sintered magnet thus obtained undergoes large deformation in the L direction. More specifically, the R-T-B-based sintered magnet underwent larger deformation in the L direction in the area B as compared with the area A.
Patent Document 1: JP 11-214216 A
Patent Document 2: JP 2007-203577 A
Patent Document 3: JP 2009-111169 A

### DISCLOSURE OF THE INVENTION

### Problems to be Solved by the Invention

The present invention has been in view of the above circumstances, and it is an object of the present invention to provide a method for producing a rare earth sintered magnet, capable of reducing variation in magnetic characteristics of a rare earth sintered magnet and suppressing deformation of the rare earth sintered magnet.

### Means for Solving the Problem

To solve the above problems, a first invention of the present application is directed to a method for producing a rare earth sintered magnet, including the steps of:

preparing a slurry including an alloy powder and a dispersion medium at a predetermined ratio, the alloy powder containing at least a rare earth element;

preparing a cavity enclosed with a mold, and an upper punch and a lower punch spaced from and opposed to each other, at least one of the upper punch and the lower punch being movable toward and away from the other one, at least one of the upper punch and the lower punch including an outlet for discharging the dispersion medium of the slurry and filtering the slurry, the mold having a cross sectional shape perpendicular to the sliding direction of the upper punch or the lower punch, the cross sectional shape being enclosed with an approximately arc-shaped outer circumference, an approximately arc-shaped inner circumference, and a pair of side circumferences connecting between the outer circumference and the inner circumference, a ratio of a distance between farthest ends of a pair of side circumferences to a distance between a top end of the outer circumference and a top end of the inner circumference being 1.5 or more, the upper punch or the lower punch being allowed to slide in a through-hole formed in the sliding direction along an outer peripheral surface including the outer circumference, an inner peripheral surface including the inner circumference, and the side circumference surfaces including the side circumferences;

injecting the slurry into the cavity in a state where the upper punch and the lower punch remain stationary to fill the cavity with the slurry, a magnetic field being applied the cavity;

producing a molded body of the alloy powder by press molding in the magnetic field, the upper punch and the lower punch coming closer to each other while applying the magnetic field; and

sintering the molded body;

wherein the slurry is injected into the cavity so that the slurry travels from one place of the top end in the cross section perpendicular to the sliding direction of one of the outer peripheral surface and the inner peripheral surface, to one place of the top end in the cross section perpendicular to the sliding direction of the other one of the outer peripheral surface and the inner peripheral surface.

Particularly, in the method for producing a rare earth sintered magnet according to the first invention of the present application, the slurry is preferably injected into the cavity so that the slurry travels from one place of the top end in the cross section perpendicular to the sliding direction of the outer peripheral surface, to one place of the top end in the cross section perpendicular to the sliding direction of the inner peripheral surface.

Particularly, in the method for producing a rare earth sintered magnet according to the first invention of the present application, the alloy powder is preferably a neodymium-iron-boron-based alloy powder containing neodymium, iron, and boron.

Particularly, in the method for producing a rare earth sintered magnet according to the first invention of the present application, an angle α formed by an injection direction of a slurry, and a line connecting between the top end of the outer circumference and the top end of the inner circumference in a cross section perpendicular to the sliding direction is preferably within a range of 0° to 30°.

A second invention of the present application is directed to a mold having a cross-sectional shape enclosed with an approximately arc-shaped outer circumference, an approximately arc-shaped inner circumference, and a pair of side circumferences connecting between the outer circumference and the inner circumference, the mold including: a through-hole formed of an outer peripheral surface including the outer circumference, an inner peripheral surface including the inner circumference, and the side circumference surfaces including the side circumferences, a ratio of a distance between farthest ends of a pair of side circumferences to a distance between a top end of the outer circumference and a top end of the inner circumference being 1.5 or more; and a slurry inlet disposed at one place of the top end of the arc of one of the outer peripheral surface and the inner peripheral surface so as to face one place of the top end of the arc of the other one of the outer peripheral surface and the inner peripheral surface.

Particularly, in the mold according to the second invention of the present application, the slurry inlet is preferably provided at one place of the top end of the arc of the outer peripheral surface so as to face one place of the top end of the arc of the inner peripheral surface.

Particularly, in the mold according to the second invention of the present application, an angle α formed by the slurry inlet, and a line connecting between the top end of the outer circumference and the top end of the inner circumference in a cross section perpendicular to the sliding direction is preferably within a range of 0° to 30°.

### Effects of the Invention

According to the present invention, it is possible to provide a method for producing a rare earth sintered magnet, capable of reducing variation in magnetic characteristics of a rare earth sintered magnet and suppressing deformation of the rare earth sintered magnet, and a mold to be suitably used for the same.

### BRIEF DESCRIPTION OF THE DRAWINGS

FIG. 1 is a schematic view of a molding apparatus to be used in a method for producing a rare earth sintered magnet according to the present invention.

FIG. 2 is a perspective view of a cavity in the molding apparatus according to the present invention.

FIG. 3 is a perspective view of a mold according to the present invention.

FIG. 4 is a schematic view showing an angle α formed by an injection direction of a slurry, and one direction.

FIG. 5 is a schematic view showing injection directions of a slurry.

FIG. 6 is a schematic view of the cavity in the molding apparatus, showing a width, a thickness, and a length of the cavity.

FIG. 7 is a schematic view showing positions at which samples are collected from the rare earth sintered magnet of the invention of the present application.

FIG. 8 is a schematic view showing a sintered magnet produced by a conventional method.

FIG. 9 is a perspective view of the sintered magnet having a latch section.

FIG. 10 is a schematic view showing a method for measuring the amount of curvature of the sintered magnet.

### MODE FOR CARRYING OUT THE INVENTION

Embodiments according to the present invention will be described in detail below with reference to the accompanying drawings. In the description below, if necessary, the terms indicative of the specific direction or position (for example, “upper”, “lower”, “right”, “left”, “front”, “rear”, and other words including these words) are used for easy understanding of the invention with reference to the drawings. The meanings of the terms do not limit the technical scope of the invention.

In the present embodiment, for the sake of easy explanation of the present invention, terms “vertical direction”, “cross direction”, and “horizontal direction” are defined as follows.

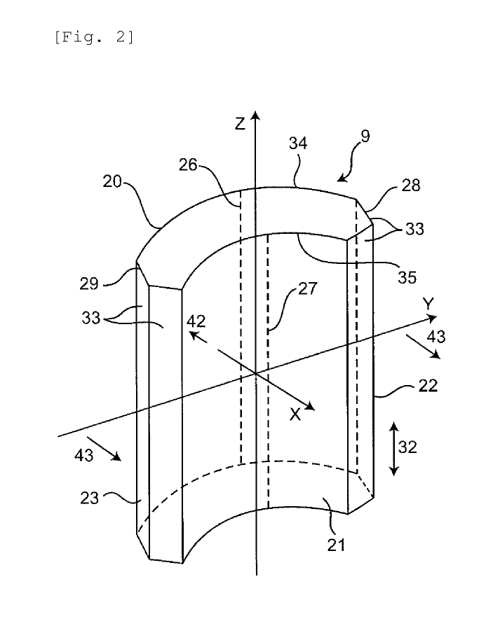

The “vertical direction” means, as shown in FIG. 2, a direction indicated by an arrow Z, i.e., a sliding direction of an upper punch and/or a lower punch (or a longitudinal direction of a cavity 9). A positive direction in which the arrow Z points is referred to as an “upper direction (upward)” and a negative direction of the arrow Z is referred to as a “lower direction (downward)”. The “cross direction” is, as shown in FIG. 2, a direction indicated by an arrow X, i.e., a direction approximately parallel to a direction of the slurry. A positive direction in which the arrow X points is referred to as a “front direction (forward)” and a negative direction of the arrow X is referred to as a “rear direction (rearward)”. The “horizontal direction” is a direction indicated by an arrow Y, i.e., a direction perpendicular to both of the “cross direction” indicated by the arrow X and the “vertical direction” indicated by the arrow Z. A positive direction in which the arrow Y points is referred to as a “right direction” and a negative direction of the arrow Y is referred to as a “left direction”.

In the following embodiments, the same parts or members are designated by the same reference numerals throughout plural drawings.

A method for producing a rare earth sintered magnet (for example, R-T-B-based sintered magnet) according to a first embodiment of the present invention includes the steps of:

preparing a slurry including an alloy powder and a dispersion medium at a predetermined ratio, the alloy powder containing at least a rare earth element;

preparing a cavity enclosed with a mold, and an upper punch and a lower punch spaced from and opposed to each other, at least one of the upper punch and the lower punch being movable toward and away from the other one, at least one of the upper punch and the lower punch including an outlet for discharging the dispersion medium of the slurry and filtering the slurry, the mold having a cross sectional shape perpendicular to the sliding direction of the upper punch or the lower punch, the cross sectional shape being enclosed with an approximately arc-shaped outer circumference, an approximately arc-shaped inner circumference, and a pair of side circumferences connecting between the outer circumference and the inner circumference, a ratio of a distance between farthest ends of a pair of side circumferences to a distance between a top end of the outer circumference and a top end of the inner circumference being 1.5 or more, the upper punch or the lower punch being allowed to slide in a through-hole formed in the sliding direction along an outer peripheral surface including the outer circumference, an inner peripheral surface including the inner circumference, and the side circumference surfaces including the side circumferences;

injecting the slurry into the cavity in a state where the upper punch and the lower punch remain stationary to fill the cavity with the slurry, a magnetic field is applied to the cavity;

producing a molded body of the alloy powder by press molding in the magnetic field, the upper punch and the lower punch coming closer to each other while applying the magnetic field; and

sintering the molded body;

wherein the slurry is injected into the cavity so that the slurry travels from one place of the top end in the cross section perpendicular to the sliding direction of one of the outer peripheral surface and the inner peripheral surface, to one place of the top end in the cross section perpendicular to the sliding direction of the other one of the outer peripheral surface and the inner peripheral surface.

In a conventional wet molding method, the slurry was injected from a right side end portion 22 (or from a left side end portion 23) to the left side end portion 23 (or the right side end portion 22) of a cavity for producing a sintered magnet for the use of a voice coil motor (VCM) as shown in FIG. 2. In the embodiments of the present invention, an area in the adjacent to the right side end portion is sometimes referred to as a vicinity of an inlet in some cases.

When the slurry is injected into the cavity from the right side end portion 22 in the negative direction of the Y axis to the left side end portion 23, because of a long distance between the right side end portion 22 and the left side end portion 23 facing to the right side end portion 22, there occurs a difference between the pressure of the vicinity of the inlet (in the vicinity of the right side end portion 22), through which the slurry is injected, and the pressure of the vicinity of the left side end portion 23. In case the slurry is injected from the right side end portion 22 under a supply pressure of, for example, 90 kg/cm², the pressure of the left side end portion 23 and the supply pressure of the right side end portion 22 will not be the same but the pressure of the left side end portion 23 will be lower than 90 kg/cm². As mentioned above, since the pressure of the vicinity of the inlet (in the vicinity of the right side end portion 22) differs from the pressure of the vicinity of the left side end portion 23, it is impossible to uniformly inject the slurry into the cavity 9 to cause a difference in density of the slurry in the cavity 9. Whereby, variation in magnetic characteristics between the right side end portion 22 and the left side end portion 23 occurs. Furthermore, the inventors have succeeded in acquiring such knowledge that, when the molded body is sintered, the magnet undergoes deformation since a difference in density leads to a difference in shrinking ratio in each portion of the sintered body.

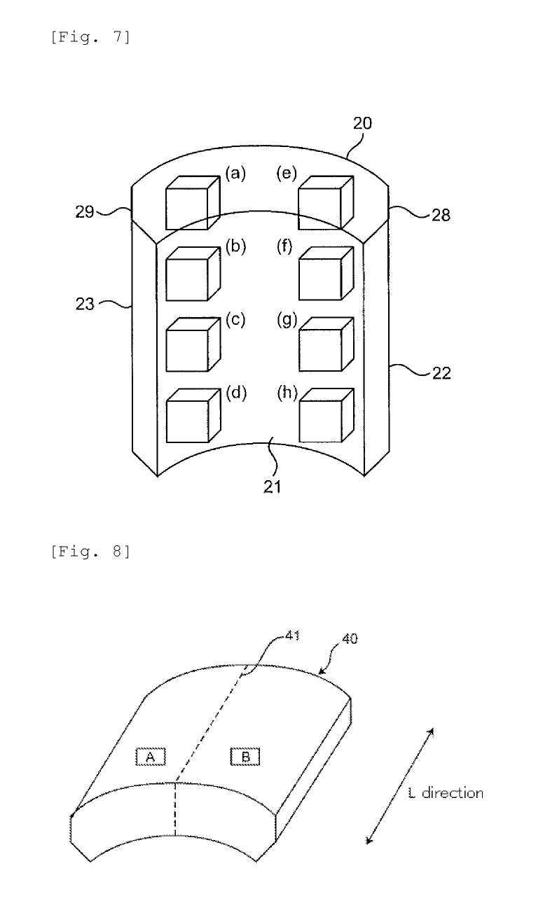

The inventors have found that, as shown in FIG. 2, in the approximately tile-shaped cavity 9 perpendicular to the sliding direction 32, variation in magnetic characteristics and deformation of the magnet are improved by injecting a slurry so that the slurry moves from one place of a top end 26 of the outer peripheral surface 20 in the cross section perpendicular to the sliding direction 32 to one place of a top end 27 of the inner peripheral surface 21 in the cross section perpendicular to the sliding direction 32, or moves from one place of the top end 27 of the inner peripheral surface 21 in the cross section perpendicular to the sliding direction 32 to one place of the top end 26 of the outer peripheral surface 20 in the cross section perpendicular to the sliding direction 32. The reason is considered as follows. Since the reason is the same in both cases where the slurry is injected from the top end 26, and the slurry is injected from the top end 27, a description is made on the case where the slurry is injected from the top end 26. In the present invention, “approximately tile shape” means, as shown in FIG. 8, a shape having a cross-sectional shape enclosed with the outer circumference and the inner circumference which are curved in the same direction and opposed to each other, and a pair of side circumferences connecting both ends of the outer circumference and both ends of the inner circumference, and having a required length in a direction perpendicular to the cross section. In the cross-sectional shape, the outer circumference may partially include a protrusion such as a latch section, and the side circumferences may be bent or curved, or extend straightly.

When the slurry is injected from the top end 26 to the top end 27, a difference between the pressure of the vicinity of the inlet provided in the top end 26 and the pressure of the vicinity of the top end 27 is reduced as compared with a difference between the pressure of the vicinity of the inlet when the slurry is injected from the right side end portion 22 and the pressure of the vicinity of the left side end portion 23, since the distance between the outer peripheral surface 20 and the inner peripheral surface 21 is shorter than that between the right side end portion 22 and the left side end portion 23. When compared with the case where the slurry is injected from the right side end portion 22, a distance between the inlet in the top end 26 and the left side end portion 23 (and the right side end portion 22) becomes shorter. Therefore, the difference between the pressure of the vicinity of the inlet provided in the top end 26 and the pressure of the vicinity of the left side end portion 23 (and the right side end portion 22) is reduced as compared with the difference between the pressure of the vicinity of the inlet at the time when the slurry is injected from the right side end portion 22 and the pressure of the vicinity of the left side end portion 23. Furthermore, the slurry injected into the top end 27 from the top end 26 is smoothly divided into a left side and a right side, since the top end 27 curves approximately equally to both sides from the top end 27. Therefore, the slurry can be uniformly injected into the left side end portion 23 and the right side end portion 22. In this way, when the slurry is injected into the top end 27 from the top end 26, the slurry can be uniformly injected into the cavity 9 as compared with in case the slurry is injected from the right side end portion 22, thus enabling reduction of difference in density. Whereby, variation in magnetic characteristics can be reduced, and also deformation of the magnet can be suppressed.

The slurry may be injected into the top end 27 from the top end 26, or injected into the top end 26 from the top end 27, with respect to the vertical direction without any limitation. However, with respect to the horizontal direction, as shown in FIG. 4, when the slurry is injected into the top end 27 from the top end 26, an angle α formed by an injection direction 31 of the slurry and a line 30 straightly drawn from the top end 26 to the top end 27 is preferably within a range of 0° to 30°, and more preferably 0° to 5°. Within such range, the slurry can be approximately uniformly filled into the cavity 9, thus enabling the production of a sintered magnet with little variation in magnetic characteristics. The angle α is most preferably 0°.

A molding apparatus 100 to be used in the method for producing a rare earth sintered magnet according to the present invention will be described in detail below.

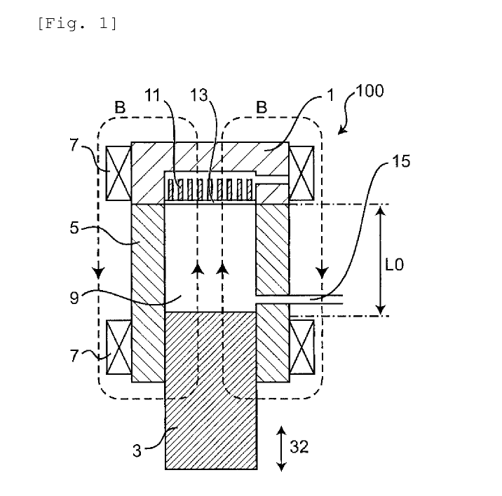

FIG. 1 is a schematic view of the molding apparatus 100 to be used in the method for producing a rare earth sintered magnet according to the present invention. FIG. 2 is a perspective view of the cavity 9 in the molding apparatus 100.

As shown in FIG. 1, in the first embodiment, the molding apparatus 100 includes a mold 5, a lower punch 3 inserted from one end of a through-hole in the mold 5, and an upper punch 1 provided at the other end of the through-hole. The cavity 9 is formed so that the cavity 9 is enclosed with the upper punch 1 (specifically, a lower surface of the upper punch 1), the lower punch 3 (specifically, an upper surface of the lower punch 3), and the mold 5 (specifically, an inner wall of the mold 5 including the outer peripheral surface 20 and the inner peripheral surface 21 of FIG. 2).

More specifically, the mold 5 is provided with the outer peripheral surface 20 and the inner peripheral surface 21 which are opposed to each other and the through-hole along the side circumference surface 33 in the sliding direction. Each of the outer peripheral surface 20 and the inner peripheral surface 21 is curved in one direction 42, i.e., in the negative direction of the X axis, perpendicular to the sliding direction 32 in which the upper punch 1 or the lower punch 3 slides. Here, “surface is curved in one direction 42 (negative direction of the X axis) perpendicular to the sliding direction 32 of the upper punch 1 or the lower punch 3” means, with an axis in parallel with the siding direction 32 of the upper punch 1 or the lower punch 3 being a center line of the surface, two sides of the surface away from the axis are displaced, respectively, along the axis in a direction 43 (positive direction of the X axis) opposite to the one direction 42 from the axis. In this way, the curvature of the first surface 20 and the second surface 21 in one direction 42 ensures uniform division of the slurry in the cavity 9, the slurry discharged from the top end 26 of the outer peripheral surface 20 or the top end 27 of the inner peripheral surface 21 to the corresponding top end of the outer peripheral surface 20 or the inner peripheral surface 21. Thus, variation in magnetic characteristics can be suppressed as mentioned above.

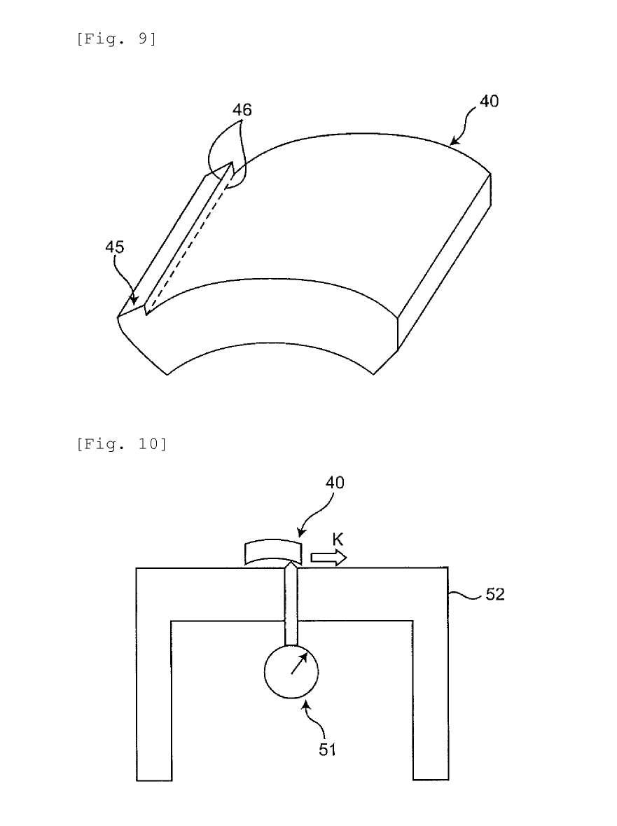

As long as the sintered magnet produced by molding in the cavity 9 including the outer peripheral surface 20 and the inner peripheral surface 21 is capable of appropriately functioning, the outer peripheral surface 20 and the inner peripheral surface 21 are not limited to continuously curved surfaces but may be discontinuously curved surfaces. Here, “continuously curved” means that, in a cross section perpendicular to the sliding direction 32 (Z axis direction), the outer peripheral surface 20 or the inner peripheral surface 21 varies so that values of slopes of tangents in contact with the outer peripheral surface 20 or the inner peripheral surface 21 continue, and “discontinuously curved” means that the outer peripheral surface 20 or the inner peripheral surface 21 varies so that the values of the slopes of the tangents discontinue. For example, as shown in FIG. 9, in case a sintered magnet 40 has a latch section 45 formed in a projecting manner, the outer peripheral surface thereof is provided with a discontinuously curved region 46 formed thereon. At the region indicated by 46, the inclination of the tangent rapidly varies, resulting in a discontinuous state.

Furthermore, the outer peripheral surface 20 and the inner peripheral surface 21 may have an approximately arc shape, and the entire surface of the outer peripheral surface 20 and the inner peripheral surface 21 may not be necessarily curved. In other words, a portion of the outer peripheral surface 20 (or the inner peripheral surface 21) may be formed of a plane surface that is approximately flat. In this case, in the cross section perpendicular to the sliding direction 32, a portion of the outer circumference 34 (or the inner circumference 35) may have a curved and approximately arc shape, and the other portion may extend straightly. Furthermore, the outer circumference 34 (or the inner circumference 35) may be formed into an approximately arc shape by joining short straight lines to form an approximately arc shape. In other words, the outer circumference 34 and the inner circumference 35 may be continuously curved or discontinuously curved as long as the outer circumference 34 and the inner circumference 35 have an approximately arc shape, or may be flat without being curved. In the cross section, in case the approximately arc shaped portion protrudes most in the negative direction of the X axis, the protruding portion is referred to as a top end. In case a straight line portion connecting two points on the arc is in parallel with the Y axis, a center of the straight line portion is referred to as atop end. The top end 27 of the inner peripheral surface 21 in the cross section perpendicular to the sliding direction 32 corresponds with the top end 27 of the inner circumference 35, and the top end 26 of the outer peripheral surface 20 in the cross section corresponds with the top end 26 of the outer circumference 34.

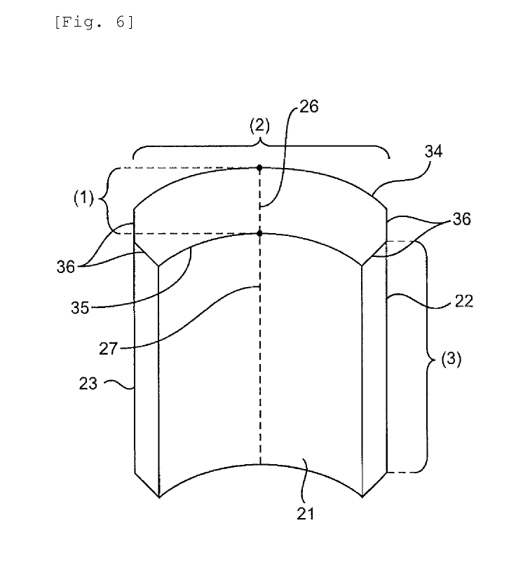

In the present invention, as shown in FIG. 6, in case a ratio of a distance (2) between the farthest ends of the pair of side circumferences 36 (pair of side circumferences 36 which is in contact with the outer circumference 34 and the inner circumference 35, and are opposed to each other) to a distance (1) between the top end 26 of the outer circumference 34 and the top end 27 of the inner circumference 35 is 1.5 or more, the present invention exerts a large effect. When the ratio is less than 1.5, because of a small difference between the distance between the top end 26 and the top end 27 and a distance between the both ends, a difference in pressure is also small in case the slurry is injected from the top end even if the slurry was injected from the ends. When the ratio is 1.5 or more, it is impossible to uniformly inject the slurry into the cavity unless the structure is not the structure of the present invention. However, when the ratio is less than 1.5, it is possible to uniformly inject the slurry into the cavity from either the top end or the ends. The ratio between the distance (1) between the top end 26 of the outer circumference 34 and the top end 27 of the inner circumference 35 and the distance (2) between the farthest ends of the pair of side circumferences 36 is obtainable by dividing the distance (2) between the farthest ends of the pair of side circumferences 36 by the distance (1) between the top end 26 of the outer circumference 34 and the top end 27 of the inner circumference 35.

The present invention is characterized in that the slurry is injected into the cavity 9 so that the slurry travels from the inlet 15 provided at one place of the top end 26 of the outer peripheral surface 20 in the cross section perpendicular to the sliding direction 32 to the top end 27 of the inner peripheral surface 21 in the cross section perpendicular to the sliding direction 32, or the slurry travels from the inlet 15 provided at one place of the top end 27 of the inner peripheral surface 21 in the cross section perpendicular to the sliding direction 32 to the top end 26 of the outer peripheral surface 20 in the cross section perpendicular to the sliding direction 32. With such configuration, the slurry discharged from one place of the top end 26 of the outer peripheral surface 20 collides against the top end 27 of the inner peripheral surface 21 that is approximately symmetrically curved with respect to the direction of the slurry (positive direction of the X axis). As a result, the slurry is uniformly divided to both sides. Since the slurry is uniformly injected into the cavity 9 to achieve the approximately same density of the slurry therein, when the slurry is subjected to a deoiling treatment to obtain a molded body formed of an alloy powder contained in the slurry, and when the molded body is subjected to sintering, variation in magnetic characteristics can be suppressed inside the sintered magnet. Similarly, the slurry discharged from one place of the top end 27 of the inner peripheral surface 21 collides against the top end 26 of the outer peripheral surface 20 that is curved approximately symmetrically with respect to the direction of the slurry (negative direction of the X axis). As a result, the slurry is uniformly divided to both sides. Also in this case, variation in magnetic characteristics is suppressed in the sintered magnet.

Particularly, it is preferable that the slurry is injected in one direction 43 (positive direction of the X axis) into the top end 27 of the inner peripheral surface 21 from the top end 26 of the outer peripheral surface 20. The top end 27 of the inner peripheral surface 21 is formed so as to protrude in a direction opposite to the direction of the slurry (negative direction of the X axis), thus causing less splashing of a slurry to the top end 26 by the slurry collided against the top end 27. Therefore, the slurry is more uniformly injected into the cavity 9 to achieve the approximately the same density of the slurry inside the cavity 9. Therefore, when the molded body formed of the alloy powder is sintered, a sintered magnet with less variation in magnetic characteristics can be produced.

In the method for producing a rare earth sintered magnet according to the present invention, an upper punch 1 and a lower punch 3 are disposed opposed to each other and away from each other via the through-hole of the mold 5. In the first embodiment, the lower punch 3 slides in the through-hole of the mold 5 so as to allow the upper punch 1 and the lower punch 3 to come closer to each other or be away from each other. The sliding punch is not limited to the lower punch 3 but may be the upper punch 1 or may be both of the upper punch 1 and the lower punch 3. Here, the upper punch 1 and the lower punch 3 are disposed opposed to each other on an axis of the sliding direction 32 of the upper punch 1 and/or the lower punch 3. Preferably, the lower surface of the upper punch 1 and the upper surface of the lower punch 3 are approximately perpendicular to the sliding direction 32 in which the upper punch 1 and/or the lower punch 3 slide(s). In this case, the pressure can be easily transferred to the molded body by the upper punch 1 and the lower punch 3, which is suitable.

Furthermore, at least one of the upper punch 1 and the lower punch 3 is provided with an outlet from which only the dispersion medium of the slurry is discharged, the slurry containing the alloy powder and the dispersion medium is discharged. That is, the slurry is filtered through the outlet. One of the upper punch 1 and the lower punch 3 or both of the upper punch 1 and the lower punch 3 slide (s) to cause the upper punch 1 and the lower punch 3 to be close to each other. In this way, the volume inside the cavity 9 is reduced and thus only a dispersion medium is discharged through the outlet. In this way, the dispersion medium is removed from the slurry, and a cake layer containing the alloy powder is formed in the cavity 9. As mentioned above, the outlet that discharges only the dispersion medium but hardly allows the alloy powder to pass therethrough is formed in the upper punch 1 or the lower punch 3 or in both of the upper punch 1 and the lower punch 3. Therefore, only the dispersion medium can be discharged from the slurry.

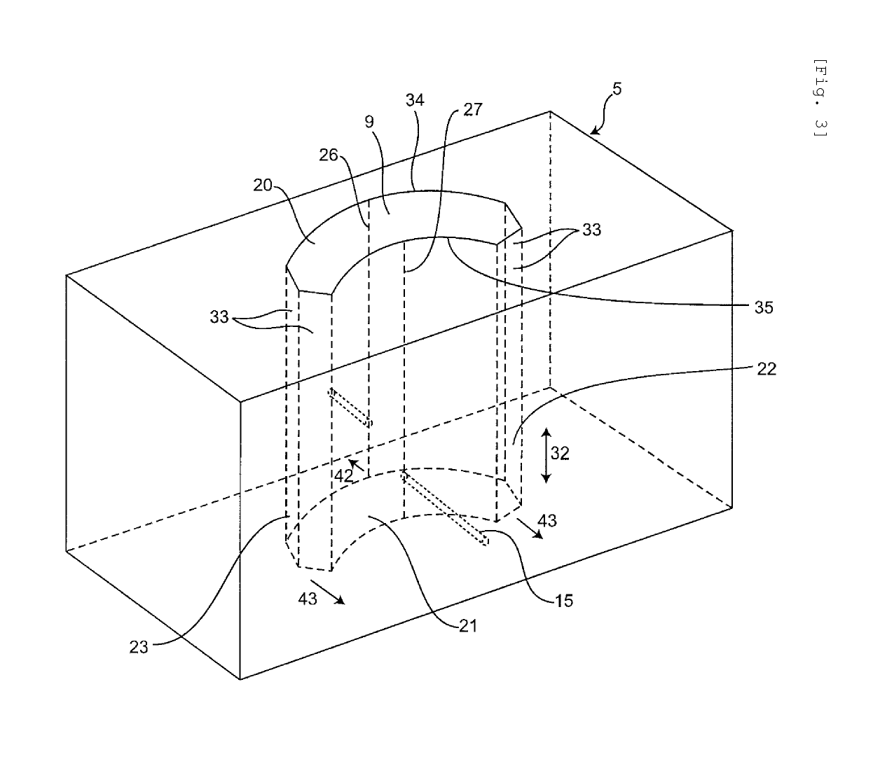

A mold 5 according to the present invention will be described in detail below. FIG. 3 is a perspective view of the mold 5. As shown in FIG. 3, the mold 5 is formed with a through-hole extending in the sliding direction 32 along the outer peripheral surface 20 and the inner peripheral surface 21 which are opposed to each other and the side circumference surfaces 33. As mentioned above, the outer peripheral surface 20 and the inner peripheral surface 21 are curved in one direction 42 that is perpendicular to the sliding direction 32 in which the upper punch 1 or the lower punch 3 slides. The top end 26 and the top end 27 are formed, respectively, on the outer peripheral surface 20 and the inner peripheral surface 21 in approximately parallel with the sliding direction 32.

The slurry inlet 15 is disposed in one place of the top end 26 of the arc of the outer peripheral surface 20 facing to one place of the top end 27 of the arc of the inner peripheral surface 21. With such configuration, the slurry discharged from one place of the top end 26 of the outer peripheral surface 20 collides against the top end 27 of the inner peripheral surface 21 that curves approximately symmetrically in both sides with respect to the direction of the slurry (positive direction of the X axis), resulting in being divided equally to both sides. The slurry is uniformly injected into the cavity 9 to achieve the approximately the same density of the slurry in the cavity 9. This suppresses variation in magnetic characteristics in the sintered magnet. The slurry inlet 15 may be disposed in one place of the top end 27 of the inner peripheral surface 21 facing to one place of the top end 26 of the outer peripheral surface 20. Similarly, the slurry discharged from one place of the top end 27 of the inner peripheral surface 21 collides against the top end 26 of the outer peripheral surface 20 that is approximately symmetrically curved with respect to the direction of the slurry (negative direction of the X axis) to be divided equally to both sides. Also, in this case, variation in magnetic characteristics is suppressed in the sintered magnet.

Particularly, it is preferable that the slurry inlet 15 is disposed in one place of the top end 26 of the arc of the outer peripheral surface 20 facing to one place of the top end 27 of the arc of the inner peripheral surface 21. The top end 27 of the inner peripheral surface 21 is formed protrudingly to a direction opposite to the direction of the slurry (negative direction of X axis), so that rebound of the slurry that collided against the top end 27 to the top end 26 is small. Therefore, the slurry is more uniformly injected into the cavity 9 to achieve the approximately the same density of a slurry inside the cavity 9. This ensures production of a sintered magnet that hardly has variation in magnetic characteristics when the molded body formed of the alloy powder is subjected to sintering.

In the mold 5 according to the present invention, in a cross section perpendicular to the through-hole, an angle α formed by the slurry inlet 15 and the line 30 connecting between the top end 27 of the inner peripheral surface 21 and the top end 26 of the outer peripheral surface 20 is preferably within a range of 0° to 30°, and more preferably 0° to 5°. Within such range, since it is possible to approximately uniformly fill the cavity 9 with a slurry, a sintered magnet with little variation in magnetic characteristics can be produced. Most preferable, an angle α is 0°.

Even when the slurry inlet 15 is inclined with respect to the line 30 at an angle of 0° to 30°, in many cases, the slurry discharged from the top end 26 (or from the top end 27) partially reaches the top end 27 (or the top end 26).

The producing method according to the present application will be described in detail below.

### 1. Molding

A molding step according to the method for producing a rare earth sintered magnet of the present invention will be described in detail below.

FIG. 1 is a schematic cross-sectional view of the molding apparatus 100. The molding apparatus 100 includes a through-hole of a mold 5 and a cavity 9 enclosed by an upper punch 1 and a lower punch 3.

### (1) Mold

The mold 5 has, as shown in FIGS. 3 and 6, a cross-sectional shape enclosed with an approximately arc-shaped outer circumference 34, an approximately arc-shaped inner circumference 35, and a pair of side circumferences 36 connecting between the outer circumference 34 and the inner circumference 35; and includes a through-hole formed of an outer peripheral surface 20 including the outer circumference 34, an inner peripheral surface 21 including the inner circumference 35, and the side circumference surfaces 33 including the side circumferences 36; a ratio of a distance between farthest ends of a pair of side circumferences 36 (maximum distance between the side circumference 36 of a left side and the side circumference 36 of a right side) to a distance between a top end 26 of the outer circumference 34 and a top end 27 of the inner circumference 35 being 1.5 or more; the mold further including a slurry inlet 15 disposed at one place of the top end 26 of the arc of the outer peripheral surface 20, or at one place of the top end 27 of the arc of the inner peripheral surface 21. More preferably, the mold is provided with a slurry inlet 15 disposed at one place of the top end 26 of the arc of one of the outer peripheral surface 20.

### (2) Molding Apparatus

As shown in FIG. 1, the cavity 9 has a length L0 extending in a molding direction. Here, the molding direction means a direction in which at least one of the upper punch and the lower punch travels in order to come close to the other one (i.e., a pressing direction or a sliding direction).

According to the embodiment shown in FIG. 1, as mentioned below, the lower punch 3 is fixed, and the upper punch 1 and the mold 5 travel integrally. Therefore, in FIG. 1, the molding direction is a direction in which the upper punch and the mold travel from top to bottom.

An electromagnet 7 is disposed on each of a side surface of the upper punch 1 and each of a lower side surface of the mold 5. Each of dashed lines B schematically indicates a magnetic field which is created by the individual electromagnet 7. As indicated by an arrow on each dashed line B, the magnetic field is applied in the cavity 9 in a direction in parallel with a bottom-to-top direction, i.e., the molding direction, of FIG. 1.

The strength of the magnetic field is preferably 1.5 T or more. It is not preferable that the strength is less than 1.5 T, since the degree of orientation of the alloy powder deteriorates and/or orientation of the alloy powder is likely to be disturbed at the time of press molding. The reason is that, when the slurry is injected into the cavity 9, a magnetization direction of the alloy powder in the slurry is more securely oriented in a direction of the magnetic field, thus obtaining high degree of orientation. The strength of the magnetic field in the cavity 9 can be determined by measurement by a Gauss meter and magnetic field analysis.

Preferably, the electromagnets 7 are disposed, as shown in FIG. 1, so that the electromagnets 7 enclose the side surfaces of the upper punch 1 and the lower side surfaces of the mold 5. This is because such positioning enables formation of the magnetic fields which are uniform and in parallel with the molding direction in the cavity 9. The term “in parallel with the molding direction” includes not only in case the magnetic fields are oriented from the lower punch 3 to the upper punch 1 (from the bottom to the top of the drawing) but also in case the magnetic fields are oriented oppositely, i.e., from the upper punch 1 to the lower punch 3 (from the top to the bottom of the drawing) as shown in FIG. 1.

The cavity 9 is connected to the inlet 15 for injecting the slurry into the cavity 9. In the embodiment shown in FIG. 1, a passage passing through the mold 5 functions as the inlet 15.

The upper punch 1 preferably includes a dispersion medium outlet 11 that filters to discharge the dispersion medium in the slurry out of the cavity 9. In a more preferable embodiment, the upper punch 1 includes a plurality of dispersion medium outlets 11 as shown in FIG. 1.

In case the upper punch 1 includes the dispersion medium outlet 11, the upper punch 1 has a filter 13, e.g., a filter cloth, a filter paper, a porous filter or a metal filter, so that the filter 13 covers the dispersion medium outlet 11. This prevents the alloy powder from coming into the dispersion medium outlet 11 more securely, thus making it possible to filter the dispersion medium in the slurry to discharge out of the cavity 9.

Instead of or in addition to the provision of the dispersion medium outlet 11 in the upper punch 1, the lower punch 3 may be provided with the dispersion medium outlet 11. As mentioned above, when the dispersion medium outlet 11 is provided in the lower punch 3, preferably, the filter 13 is disposed so as to cover the dispersion medium outlet 11.

### (3) Injection of Slurry

Next, it is preferable to inject the slurry into the cavity 9 at a flow rate of 20 to 600 cm³/second (injection rate of a slurry). When the flow rate is 20 cm³/second or less, it is difficult to adjust the flow rate. This is because there is in case the slurry cannot be injected into the cavity due to pipe resistance. On the other hand, when the flow rate exceeds 600 cm³/second, variation in density occurs at portions of the molded body, thus causing breakage of the molded body when the molded body is taken out after the press molding or breakage of the molded body due to shrinkage when the molded body is sintered. This is also because disorder of orientation occurs in the vicinity of the slurry inlet.

A flow rate of a slurry is preferably within a range of 20 cm³/second to 400 cm³/second, and more preferably 20 cm³/second to 200 cm³/second. When the flow rate is controlled within a preferable range and a more preferable range, variation in density in portions of the molded body can be further reduced.

The flow rate of a slurry can be controlled so that a flow rate adjusting valve of a hydraulic system having a hydraulic cylinder as a slurry feeder is adjusted to change the flow rate of oil to be fed into the hydraulic cylinder, resulting in changing a rate of hydraulic cylinder.

The slurry contains an alloy powder containing a rare earth element and a dispersion medium such as oil. The inlet 15 is connected to a slurry feeder (not shown) from which the slurry pressurized by the slurry feeder is injected into the cavity 9 through the inlet 15. Initially, the upper punch 1 and the lower punch 3 are in a stationary state, and thus the length in the molding direction of the cavity 9 (i.e., the distance between the upper punch 1 and the lower punch 3) remains constant at L0. The magnetic field, as shown in FIG. 1, is applied in the cavity 9. The slurry is preferably supplied under a pressure of 1.96 MPa to 14.7 MPa (20 kgf/cm² to 150 kgf/cm²).

A magnetization direction of the alloy powder contained in the slurry that has injected into the cavity 9 becomes in parallel with the direction of the magnetic field, i.e., in parallel with the molding direction, due to the magnetic field applied in the cavity 9.

### (4) Press Molding

The press molding is performed after the cavity 9 is filled with the injected slurry in this way.

The press molding is performed so that at least one of the upper punch 1 and the lower punch 3 is moved to cause the upper punch 1 and the lower punch 3 to come close to each other, whereby, the volume of the cavity 9 is reduced. In the first embodiment as shown in FIG. 1, the lower punch 3 is fixed and the upper punch 1 and the mold 5 integrally travels from the top to the bottom in FIG. 1, thus performing press molding.

When the press molding is performed in the magnetic field and thus the volume of the cavity 9 decreases, the dispersion medium is filtered to discharge through the dispersion medium outlet 11. On the other hand, the alloy powder remains in the cavity 9 to form a cake layer. Thereafter, the cake layer spreads all over the cavity 9, resulting in achieving bonding between the alloy powders. As used herein, “cake layer” means a layer of which concentration of alloy powder becomes high due to filtering and discharge of the dispersion medium in the slurry to the outside of the cavity 9.

In the press molding in the magnetic field according to the invention of the present application, a ratio (L0/LF) between a length (L0) of the cavity 9 in the molding direction before the press molding is performed and a length (LF) of the obtained molded body in the molding direction is within a range of 1.1 to 1.4. When the ratio L0/LF is 1.1 to 1.4, the alloy powder of which magnetization direction is oriented to a direction of the magnetic field rotates by a force that is applied when the alloy powder is subjected to the press molding. This ensures reduction of a risk that the magnetization direction thereof deviates from a direction in parallel with the magnetic field, thus achieving a further improvement in magnetic characteristics. To obtain the ratio L0/LF of 1.1 to 1.4, for example, a method of increasing the concentration of the slurry to a high value (for example, concentration of 84% or more) is exemplified.

In the first embodiment shown in FIG. 1, the lower punch 3 is fixed, and the upper punch 1 and the mold 5 are integrally moved to perform press molding in the magnetic field, but not limited to this as mentioned above.

### 2. Other Steps

Steps other than the molding step will be described below.

### (1) Production of Slurry

Composition of Alloy Powder

An alloy powder may have the composition of a known rare earth sintered magnet containing the R-T-B-based sintered magnet (R means at least one of rare earth elements (concept including yttrium (Y)), T means iron (Fe) or a combination of iron and cobalt (Co), and B means boron). Preferable composition of the R-T-B-based sintered magnet will be described below.

R is selected from at least one of Nd, Pr, Dy, and Tb. However, it is preferable that R contains either one of Nd and Pr. It is more preferable that a combination of the rare earth elements represented by Nd—Dy, Nd—Tb, Nd—Pr—Dy, or Nd—Pr—Tb is used.

Among R, Dy and Tb particularly exert the effect of improving H_{cj}. The alloy powder may contain a small amount of another rare earth element, such as Ce or La, and, for example, Mischmetal or didymium, in addition to the above elements. The element R is not necessarily a pure element and may include inevitable impurities as long as it is available for industrial use. The content of the element R may be conventionally known content, and preferably can be within a range of 25 to 35% by mass. For the content of the element R of less than 25% by mass, the alloy powder cannot sometimes obtain the adequate magnetic characteristics, especially, the high H_{cj}. On the other hand, for the content of the element R exceeding 35% by mass, Bᵣ may be sometimes reduced.

The element T contains iron, and may be substituted with cobalt (Co) by 50% by mass or less. The element Co is effective for improving the temperature characteristics and corrosion resistance, and the alloy powder may contain 10% by mass of less of Co. The content of the element T occupies the balance of R and B, or R and B and below-mentioned M.

The content of the element B may be known content, and preferably can be within a range of 0.9 to 1.2% by mass. For the content of the element B of 0.9% by mass or less, the alloy powder cannot sometimes obtain the high H_{cj}. On the other hand, for the content of the element B of 1.2% by mass or more, Bᵣ may be sometimes reduced. Apart of the elements B may be substituted with the element C (carbon). The substitution with the element C has the effect of improving the corrosion resistance of the magnet. In adding the elements B and C, the total content of the elements B and C is preferably controlled so as to have the above preferable content of the element B by converting the number of substituent C atoms into the number of B atoms.

In addition to the above elements, the element M can be added for improving H_{cj}. The element M is at least one element selected from the group consisting of Al, Si, Ti, V, Cr, Mn, Ni, Cu, Zn, Ga, Zr, Nb, Mo, In, Sn, Hf, Ta, and W. The amount of addition of the element M is preferably 2.0% by mass or less. When the addition amount of the element M exceeds 5.0% by mass, Bᵣ may be sometimes reduced.

Inevitable impurities can be permitted.

Method for Producing Alloy Powder

The alloy powder is obtained in the following manner, for example, an ingot or a flake of a raw material alloy for a rare earth sintered magnet having a desired composition is produced by a melting method, and hydrogen is absorbed (occluded) in the ingot and the flake, thus performing hydrogen grinding to obtain a coarsely ground power.

Then, the coarsely ground power is further ground by a jet mill to obtain a fine powder (alloy powder).

A method for producing a raw material alloy for a rare earth sintered magnet will be exemplified below.

The alloy ingot is obtainable by an ingot casting method in which metal with finally required composition prepared in advance is melted and poured into a mold.

The alloy flake can be produced by a quenching method typified by a strip casting method or a centrifugal casting method in which a solidified alloy thinner than an alloy produced by an ingot casting method is quenched by bringing the molten metal into contact with a single roll, a twin roll, a rotation disk, or a rotating cylinder mold.

In the present invention, a material produced by either one of the ingot casting method and the quenching method can be used. However, a material produced by the quenching method is preferred.

The raw material alloy (quenched alloy) for a rare earth sintered magnet, produced by the quenching method, usually has a thickness within a range of 0.03 mm to 10 mm and has a flake shape. The molten alloy starts solidification from a surface in contact with a cooling roll (roll contact surface), and a crystal grain grows into a columnar shape in a thickness direction from the roll contact surface. The quenched alloy is cooled within a shorter period of time as compared with the alloy (ingot alloy) produced by a conventional ingot casting method (mold casting method), and thus the structure is refined, leading to a small crystal grain size. The quenched alloy has a wide grain boundary area. Since an R-rich phase expands largely within the grain boundary, the quenching method is excellent in dispersibility of the R-rich phase.

Therefore, the quenched alloy is likely to undergo grain boundary fracture by the hydrogen grinding method. The hydrogen grinding of the quenched alloy can control an average size of the hydrogen-ground powder (coarsely ground power) within a range of 1.0 mm or less.

The coarsely ground power thus obtained is ground, for example, by a jet mill to obtain an alloy powder having a D50 grain size of 3 to 6 lam as measured by an airflow dispersion type laser analysis method.

The jet mill is preferably used in (a) atmosphere composed of a nitrogen gas and/or an argon gas (Ar gas) substantially having an oxygen content of 0% by mass, or (b) atmosphere composed of a nitrogen gas and/or an Ar gas having an oxygen content of 0.005 to 0.5% by mass.

In order to control the amount of nitrogen in the obtained sintered body, the atmosphere in the jet mill is replaced by an Ar gas atmosphere, and then a trace amount of a nitrogen gas is introduced thereinto to adjust the concentration of the nitrogen gas in the Ar gas.

Dispersion Medium

Examples of preferable dispersion medium to be used in the present invention include mineral oil and synthetic oil.

Although the kind of mineral oil or synthetic oil is not specified, when kinematic viscosity at normal temperature exceeds 10 cSt, the increased viscosity enhances cohesion between alloy powders, and thus an adverse influence may be sometimes exerted on orientation property of the alloy powder when wet molding is performed in magnetism.

Therefore, the kinematic viscosity at the normal temperature of mineral oil or synthetic fluid is preferably 10 cSt or less. When a fractional distillation point of mineral oil or synthetic oil exceeds 400° C., it becomes difficult to perform deoiling after obtaining the molded body. As a result, the residual carbon amount in the sintered body may increase to cause deterioration of magnetic characteristics.

Therefore, the fractional distillation point of mineral oil or synthetic oil is preferably 400° C. or lower.

It is also possible to use vegetable oil as the dispersion medium. The vegetable oil means oil extracted from plants and is not limited to oil extracted from specific kinds of plants. Examples of the vegetable oil include soybean oil, rapeseed oil, corn oil, safflower oil, and sunflower oil.

Preparation of Slurry

Slurry can be obtained by mixing the obtained alloy powder with a dispersion medium.

There is no particular limitation on a mixing ratio of the alloy powder to the dispersion medium. However, in order to reduce variation in size and weight of a molded body obtained by wet molding, a ratio of the alloy powder to the mixture is within a range of 70% to 90%, more preferably 75% to 88%, and most preferably 83% to 86%.

There is no particular limitation on the method for mixing the alloy powder with dispersion medium.

An alloy powder and a dispersion medium are separately prepared and, followed by weighing of predetermined amount of them to produce a mixture.

Alternatively, in the case of dry grinding of a coarsely ground powder by jet mill or the like to obtain an alloy powder, a container accommodating a dispersion medium is disposed at an alloy powder discharging opening of a grinder such as a jet mill, and the alloy powder obtained by grinding is directly collected in the dispersion medium accommodated in the container to obtain a slurry. In this case, it is preferable that the container is also placed under atmosphere composed of a nitrogen gas and/or Ar gas, and then obtained alloy powder is directly collected into the container of dispersion medium without exposing the alloy powder to atmospheric air to prepare a slurry.

It is also possible that the coarsely ground powder kept in dispersion medium is wet-ground in a state of being held in the dispersion medium using a vibration mill, a ball mill, or an attritor to obtain a slurry composed of the alloy powder and the dispersion medium.

### (2) Deoiling Treatment

A dispersion medium such as mineral oil or synthetic oil remains in the molded body obtained by the above mentioned wet molding method (longitudinal magnetic field molding method).

When the temperature of the molded body in this state is raised rapidly from normal temperature to, for example, 950 to 1,150° C., which is a sintering temperature, the inner temperature of the molded body rises rapidly, and thus the dispersion medium remaining in the molded body may react with a rare earth element of the molded body to produce rare earth carbide. In this way, when the rare earth carbide is produced, generation of a liquid phase sufficient for sintering is suppressed, thus failing to obtain a sintered body having sufficient density and leading deterioration of magnetic characteristics.

Therefore, before sintering, the molded body is preferably subjected to a deoiling treatment.

The deoiling treatment is preferably performed under the conditions at 50 to 500° C., and more preferably 50 to 250° C., under a pressure of 13.3 Pa (10⁻¹ Torr) or less for 30 minutes or more. This is because that the dispersion medium remaining in the molded body can be sufficiently removed.

A heating and holding temperature of the deoiling treatment is not limited to a single temperature as long as the heating and holding temperature is within a range of 50 to 500° C., and the deoiling treatment may be performed at two or more different temperatures. It is also possible to obtain the same effect as in the case of to the above mentioned preferable deoiling treatment by subjected to a deoiling treatment under the conditions of a pressure of 13.3 Pa (10⁻¹ Torr) or less and a temperature rise rate of from room temperature to 500° C. of 10° C./minute or less, an more preferably 5° C./minute or less.

### (3) Sintering

Sintering of the molded body is preferably performed under a pressure of 0.13 Pa (10⁻³ Torr) or less, and more preferably 0.74 Pa (5.0×10⁻⁴ Torr) or less, at a temperature within a range of 1,000° C. to 1,150° C. In order to avoid oxidation by sintering, it is preferable to replace the remaining gas of atmosphere by inert gas such as helium and argon.

### (4) Heat Treatment

The obtained sintered body is preferably subjected to a heat treatment. By the heat treatment, the magnetic characteristics can be enhanced. Publicly known conditions can be employed for the heat treatment, e.g., temperature of the heat treatment and time for the heat treatment.

### EXAMPLES

### Example 1

Melting was conducted by a high frequency melting furnace so as to obtain the composition of Nd_{20.7}, Pr_{5.5}, Dy_{5.5}, B_{1.0}, Co_{2.0}, Al_{0.1}, Cu_{0.1} and a balance of Fe (% by mass), and the molten alloy was quenched by a strip casting method to obtain a flake-shaped alloy having a thickness of 0.5 mm. The alloy was coarsely ground by a hydrogen grinding method and then finely ground by a jet mill using a nitrogen gas having an oxygen content of 10 ppm (0.001% by mass, i.e., substantially 0% by mass). A grain size D50 of the obtained alloy powder was 4.7 μm. The alloy powder was immersed in mineral oil (manufactured by Idemitsu Kosan Co., Ltd. under the trade name of MC OIL P-02) having a fractional distillation point of 250° C. in a nitrogen atmosphere, and kinematic viscosity at room temperature of 2 cSt to prepare a slurry. The concentration of the slurry was 85% by weight.

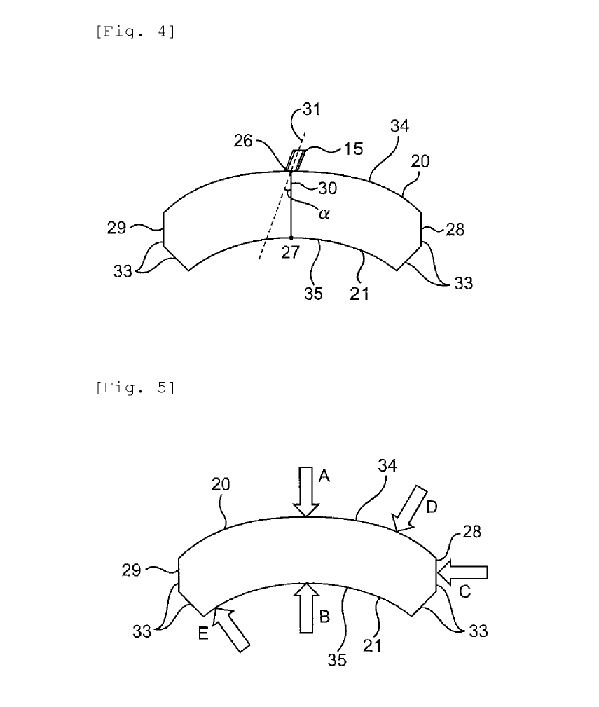

A parallel magnetic field molding apparatus 100 shown in FIG. 1 was used for press molding. A cavity 9 was formed of an upper punch 1, a lower punch 3, and a mold 5, and had a cross-sectional shape seen from a molding direction as shown in FIG. 5. The magnetic field was applied into the cavity 9 in a depth direction of the cavity 9. Then, slurry was injected into the cavity 9 from a cavity feeder. In that case, the slurry was injected into the cavity 9 from a direction (A) of FIG. 5. In Example 1, the slurry was injected into the cavity 9 from one place of the top end of the outer peripheral surface. After the cavity 9 was filled with the slurry, press molding was performed under a molding pressure of 98 MPa (1 ton/cm³).

The molded body thus obtained was heated from a room temperature to 150° C. at 1.5° C./minute in vacuum, and the temperature was maintained for 1 hour. Then, the temperature was raised to a 500° C. at 1.5° C./minute to remove mineral oil in the molded body. The temperature was raised from 500° C. to 1,100° C. by 20° C./minute, and the molded body was sintered by maintaining at the temperature for 2 hours. The obtained sintered body was subjected to a heat treatment at 900° C. for 1 hour, followed by a heat treatment at 600° C. for 1 hour. The sintered magnet thus obtained had an approximately tile shape, as shown in FIG. 6, and has a width (width is indicated by (2) in FIG. 6.) of 30 mm, a thickness (height is indicated by (1) in FIG. 6.) of 10 mm, and a length (length is indicated by (3) in FIG. 6.) of 60 mm.

### Example 2

A sintered magnet was produced under the same conditions as in Example 1, except that the slurry was injected into the cavity 9 from a direction (B) of FIG. 5 when the slurry was injected into the cavity 9 from the cavity feeder 15. In Example 2, the slurry was injected into the cavity 9 from one place of the top end of the inner peripheral surface of the cavity 9.

### Comparative Example 1

A sintered magnet was produced under the same conditions as in Example 1, except that the slurry was injected into the cavity 9 from a direction (C) of FIG. 5 when the slurry was injected into the cavity 9 from the cavity feeder 15. In Comparative Example 1, the slurry was injected into the cavity 9 from one place of the side circumference surface of the cavity 9.

### Comparative Example 2

A sintered magnet was produced under the same conditions as in Example 1, except that the slurry was injected into the cavity 9 from a (D) direction of FIG. 5 when the slurry was injected into the cavity 9 from the cavity feeder 15. In Comparative Example 2, the slurry was injected into the cavity 9 from one of the end portions of the outer peripheral surface of the cavity 9.

### Comparative Example 3

A sintered magnet was produced under the same conditions as in Example 1, except that the slurry was injected into the cavity 9 from a direction (E) of FIG. 5 when the slurry was injected into the cavity 9 from the cavity feeder 15. In Comparative Example 2, the slurry was injected into the cavity 9 from one of the end portions of the inner peripheral surface of the cavity 9.

The amount of curvature in a length direction of each of the sintered magnets obtained in Examples 1 and 2, and Comparative Examples 1 to 3 was measured. The measuring method is as follows. As shown in FIG. 10, an R-T-B-based sintered magnet 40 was placed on a flat board, and a dial gage 51 was adjusted at a zero point. Then, the sintered magnet 40 was slid in a K direction to measure the maximum value of a sliding width of the dial gage 51. The results are shown in Table 1.

TABLE 1

| | | | | Com- | Com- |
|---|---|---|---|---|---|
| | Example | Example | Comparative | parative | parative |
| | 1 | 2 | Example 1 | Example 2 | Example 3 |
| Amount of | 0.1 mm | 0.25 mm | 1.0 mm | 1.2 mm | 1.4 mm |
| curvature | | | | | |

As shown in Table 1, the sintered magnets (Examples 1 and 2) of the present invention, in which the slurry was injected into the cavity 9 from one place of the top end of the outer peripheral surface or from one place of the top end of the inner peripheral surface, exhibit little curvature, namely, deformation is suppressed. The sintered magnets of the Comparative Examples 1 to 3 exhibit the amount of curvature within a range of 1.0 mm to 1.4 mm, namely, significant deformation occurs.

Magnets having the same size were cut out from 8 positions (a) to (h) shown in FIG. 7 from each of the sintered magnets obtained in Examples 1 and 2, and Comparative Examples 1 to 3, and magnetic characteristics (Bᵣ, H_{cJ}) of each of magnets after cutting-out were measured by a BH tracer. Values of Bᵣ are shown in Table 2. In the drawing, an upper side is an upper punch side and a lower side is a lower punch side, and the slurry is injected at the position in the right side in Comparative Examples 1 and 2 and the slurry is injected at the position in the left side in Comparative Example 3. Among 8 positions shown in FIG. 7, (a) and (e) correspond to the vicinity of the upper surface of the molded body that was in contact with the upper punch at the time of press molding, and the magnets are aligned along the lower punch side direction at approximately the same distance between (a) and (e), (b) and (f), (c) and (g), and (d) and (h) from (a) and (e), and (d) and (h) correspond to the vicinity of the lower surface of the molded body in contact with the lower punch at the time of press molding. H_{cJ} of each magnet (a) to (h) was within a range of 1,710 to 1,790 kA/m.

TABLE 2

| | Samples | | | | | | | |
|---|---|---|---|---|---|---|---|---|
| | Bᵣ (T) | | | | | | | |
| Nos. | (a) | (b) | (c) | (d) | (e) | (f) | (g) | (h) |
| Example 1 | 1.33 | 1.33 | 1.33 | 1.34 | 1.33 | 1.33 | 1.33 | 1.34 |
| Example 2 | 1.32 | 1.32 | 1.32 | 1.34 | 1.32 | 1.32 | 1.33 | 1.33 |
| Comparative | 1.28 | 1.29 | 1.30 | 1.31 | 1.31 | 1.33 | 1.32 | 1.34 |
| Example 1 | | | | | | | | |
| Comparative | 1.26 | 1.33 | 1.30 | 1.34 | 1.32 | 1.26 | 1.29 | 1.28 |
| Example 2 | | | | | | | | |
| Comparative | 1.31 | 1.32 | 1.34 | 1.32 | 1.30 | 1.26 | 1.30 | 1.25 |
| Example 3 | | | | | | | | |

As shown in Table 2, the sintered magnets (Examples 1 and 2) of the present invention, in which the slurry was injected into the cavity 9 from one place of the top end of the outer peripheral surface or one place of the top end of the inner peripheral surface, exhibit little variation in magnetic characteristics of Bᵣ in portions of the single magnet body, namely, uniform. Variation in magnetic characteristics of Bᵣ in portions of the single molded body increases in Comparative Examples 1 to 3.

As mentioned above, it has been found that, according to the method for producing a rare earth sintered magnet of the present invention, the rare earth sintered magnet with little variation in magnetic characteristics can be provided.

This application claims priority on Japanese Patent Application No. 2012-146708, the disclosure of which is incorporated by reference herein.

### DESCRIPTION OF REFERENCE NUMERALS

1 Upper punch
3 Lower punch
5 Mold
7 Electromagnet
9 Cavity
11 Dispersion medium outlet
13 Filter
15 Inlet
20 Outer peripheral surface
21 Inner peripheral surface

1. A method for producing a rare earth sintered magnet, comprising the steps of:
preparing a slurry including an alloy powder and a dispersion medium at a predetermined ratio, the alloy powder containing at least a rare earth element;
preparing a cavity enclosed with a mold, and an upper punch and a lower punch spaced from and opposed to each other, at least one of the upper punch and the lower punch being movable toward and away from the other one, at least one of the upper punch and the lower punch including an outlet for discharging the dispersion medium of the slurry and filtering the slurry, the mold having a cross sectional shape perpendicular to the sliding direction of the upper punch or the lower punch, the cross sectional shape being enclosed with an approximately arc-shaped outer circumference, an approximately arc-shaped inner circumference, and a pair of side circumferences connecting between the outer circumference and the inner circumference, a ratio of a distance between farthest ends of a pair of side circumferences to a distance between a top end of the outer circumference and a top end of the inner circumference being 1.5 or more, the upper punch or the lower punch being allowed to slide in a through-hole formed in the sliding direction along an outer peripheral surface including the outer circumference, an inner peripheral surface including the inner circumference, and the side circumference surfaces including the side circumferences;
injecting the slurry into the cavity in a state where the upper punch and the lower punch remain stationary to fill the cavity with the slurry, a magnetic field being applied to the cavity;
producing a molded body of the alloy powder by press molding in the magnetic field, the upper punch and the lower punch coming closer to each other while applying the magnetic field; and
sintering the molded body;
wherein the slurry is injected into the cavity so that the slurry travels from one place of the top end in the cross section perpendicular to the sliding direction of one of the outer peripheral surface and the inner peripheral surface, to one place of the top end in the cross section perpendicular to the sliding direction of the other one of the outer peripheral surface and the inner peripheral surface.

2. The method for producing a rare earth sintered magnet according to claim 1, wherein the slurry is injected into the cavity so that the slurry travels from one place of the top end in the cross section perpendicular to the sliding direction of the outer peripheral surface, to one place of the top end in the cross section perpendicular to the sliding direction of the inner peripheral surface.

3. The method for producing a rare earth sintered magnet according to claim 1, wherein the alloy powder is a neodymium-iron-boron-based alloy powder containing neodymium, iron, and boron.

4. The method for producing a rare earth sintered magnet according to claim 1, wherein an angle α formed by an injection direction of a slurry, and a line connecting between the top end of the outer circumference and the top end of the inner circumference in a cross section perpendicular to the sliding direction is within a range of 0° to 30°.

5. A mold having a cross-sectional shape enclosed with an approximately arc-shaped outer circumference, an approximately arc-shaped inner circumference, and a pair of side circumferences connecting between the outer circumference and the inner circumference, the mold comprising:
a through-hole formed of an outer peripheral surface including the outer circumference, an inner peripheral surface including the inner circumference, and the side circumference surfaces including the side circumferences, a ratio of a distance between farthest ends of a pair of side circumferences to a distance between a top end of the outer circumference and a top end of the inner circumference being 1.5 or more; and
a slurry inlet disposed at one place of the top end of the arc of one of the outer peripheral surface and the inner peripheral surface so as to face one place of the top end of the arc of the other one of the outer peripheral surface and the inner peripheral surface.

6. The mold according to claim 5, wherein the slurry inlet is provided at one place of the top end of the arc of the outer peripheral surface.

7. The mold according to claim 5, wherein an angle α formed by the slurry inlet, and a line connecting between the top end of the outer circumference and the top end of the inner circumference in a cross section perpendicular to the sliding direction is within a range of 0° to 30°.
